(19) United States
(12) Patent Application Publication
(10) Pub. No.: US 2020/0265730 A1
(43) Pub. Date: Aug. 20, 2020

(54) TERRAIN PREDICTION METHOD, DEVICE AND SYSTEM, AND UNMANNED AERIAL VEHICLE

(71) Applicant: SZ DJI TECHNOLOGY CO., LTD., Shenzhen (CN)

(72) Inventors: Shirong WANG, Shenzhen (CN); Chunming WANG, Shenzhen (CN); Junxi WANG, Shenzhen (CN)

(21) Appl. No.: 16/868,044

(22) Filed: May 6, 2020

Related U.S. Application Data
(63) Continuation of application No. PCT/CN2017/116862, filed on Dec. 18, 2017.

(51) Int. Cl. G08G 5/00; G08G 5/06; G01S 13/935

(52) U.S. Cl. CPC G08G 5/0086; G08G 5/0069; G01S 13/935; G08G 5/06

(57) ABSTRACT

An unmanned aerial vehicle (UAV) includes a radar configured to perform ranging on a ground during rotation and a terrain prediction device communicatively connected to the radar. The terrain prediction device includes a memory storing a computer program and a processor configured to execute the computer program to acquire N pieces of ranging data each being obtained by the radar when a rotation angle of the radar is within a preset angle interval, and determining a terrain parameter of the ground according to the N pieces of ranging data. N is an integer greater than 1. The terrain parameter includes at least one of a gradient or a flatness.

### CROSS-REFERENCE TO RELATED APPLICATION

This application is a continuation of International Application No. PCT/CN2017/116862, filed Dec. 18, 2017, the entire content of which is incorporated herein by reference.

### TECHNICAL FIELD

The present disclosure relates to the unmanned aerial vehicle technology field, and more particularly, to a terrain prediction method, device, and system, and an unmanned aerial vehicle.

### BACKGROUND

Currently unmanned aerial vehicles can be used in a variety of scenarios. Taking the agricultural industry as an example, unmanned aerial vehicles can cultivate land, sow, spray pesticides, and harvest crops, which brings great benefits to the agricultural sector. In these operating scenarios, most unmanned aerial vehicles need to fly near the ground, and avoid accidentally hitting the ground when climbing uphill. On a relatively flat ground, based on Global Positioning System (GPS) and Inertial Measurement Unit (IMU) data, unmanned aerial vehicles can successfully complete the above tasks. In rough terrain, unmanned aerial vehicles need to adjust their actions in advance, such as climbing, downhill, deceleration, braking, etc., to achieve near-ground flight or even contour flight, making the unmanned aerial vehicle to complete the above operations better. Therefore, unmanned aerial vehicles need to predict the terrain conditions of the ground on which they operate. In the existing technologies, a car is driven through the ground, during the passing process, the relative change of acceleration is generated by the contact between the car and the ground, and then the terrain of the ground is estimated based on the change in acceleration. However, the contact between the car and the ground generates high frequency noise, which affects the amount of change in acceleration, and hence affects the accuracy of terrain prediction.

### SUMMARY

In accordance with the present disclosure, there is provided an unmanned aerial vehicle (UAV) including a radar configured to perform ranging on a ground during rotation and a terrain prediction device communicatively connected to the radar. The terrain prediction device includes a memory storing a computer program and a processor configured to execute the computer program to acquire N pieces of ranging data each being obtained by the radar when a rotation angle of the radar is within a preset angle interval, and determining a terrain parameter of the ground according to the N pieces of ranging data. N is an integer greater than 1. The terrain parameter includes at least one of a gradient or a flatness.

### BRIEF DESCRIPTION OF THE DRAWINGS

In order to more clearly explain the embodiments of the present disclosure, the drawings used in the description of the embodiments will be briefly introduced below. Obviously, the drawings in the following description are some embodiments of the present disclosure. For those of ordinary skill in the art, other drawings can be obtained based on these drawings without creative efforts.

FIG. 1 is a schematic structural diagram of an agricultural unmanned aerial vehicle according to one embodiment of the present disclosure.

FIG. 2 is a flowchart of a terrain prediction method according to one embodiment of the present disclosure.

FIG. 3 is a schematic diagram of radar ranging according to one embodiment of the present disclosure.

FIG. 4 is a schematic structural diagram of a terrain prediction device according to one embodiment of the present disclosure.

FIG. 5 is a schematic structural diagram of an unmanned aerial vehicle according to one embodiment of the present disclosure.

FIG. 6 is a schematic structural diagram of a terrain prediction system according to one embodiment of the present disclosure.

### DETAILED DESCRIPTION OF THE EMBODIMENTS

To better illustrate the objectives, technical solutions, and advantages of embodiments of the present disclosure, technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Embodiments of the present disclosure provide a terrain prediction method, device, and system, and an unmanned aerial vehicle. The unmanned aerial vehicle can be an agricultural unmanned aerial vehicle, such as a rotorcraft, e.g., a multi-rotor aircraft propelled by a plurality of propulsion devices through air, and embodiments of the present disclosure are not limited to these terms.

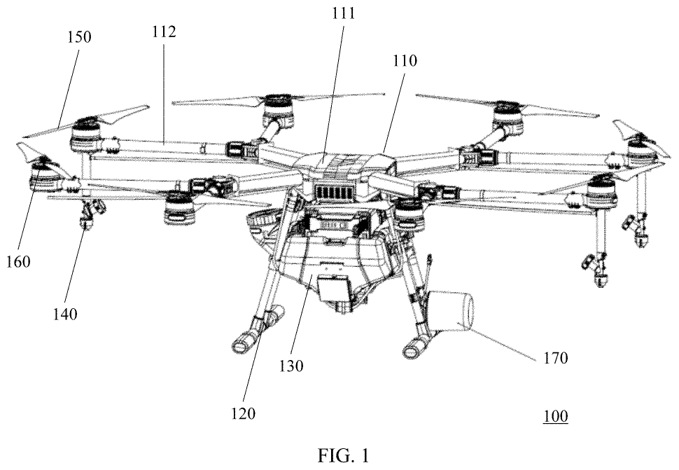

FIG. 1 is a schematic structural diagram of an agricultural unmanned aerial vehicle 100 according to one embodiment of the present disclosure. This embodiment is described by taking a rotary wing unmanned aerial vehicle (UAV) as an example.

An agricultural unmanned aerial vehicle 100 may include a power system, a flight control system, and a rack. The agricultural unmanned aerial vehicle 100 can wirelessly communicate with a control terminal that can display flight information of the agricultural unmanned aerial vehicle, etc. The control terminal may communicate with the agricultural unmanned aerial vehicle 100 in a wireless manner for remotely controlling the agricultural unmanned aerial vehicle 100.

A rack may include a vehicle body 110 and a stand 120 (also referred to as a landing gear). The vehicle body 110 may include a center frame 111 and one or more arms 112 connected to the center frame 111. The one or more arms 112 extend radially from the center frame. The stand 120 is connected to the vehicle body 110, and is used for supporting the agricultural unmanned aerial vehicle 100 during landing. A liquid storage tank 130 used to store chemical liquid or water is mounted between the stands 120. A spray head 140 is mounted at the end of the arm 112, and the liquid in the liquid storage tank 130 is pumped into the spray head 140 through a pump, and is sprayed out by the spray head 140.

The power system may include one or more electronic speed controllers (simply referred to as ESCs), one or more propellers 150, and one or more motors 160 corresponding to the one or more propellers 150. The motor 160 is connected between the electronic speed controller and the propeller 150. The motor 160 and the propeller 150 are configured on the arm 112 of the agricultural unmanned aerial vehicle 100. The electronic speed controller is used to receive the driving signal generated by the flight control system and provide a driving current to the motor according to the driving signal to control the rotation speed of the motor 160. The motor 160 is used to drive the propeller 150 to rotate, thereby providing power for the flight of the agricultural unmanned aerial vehicle 100, and the power enables the agricultural unmanned aerial vehicle 100 to perform movements with one or more degrees of freedom. In some embodiments, the agricultural unmanned aerial vehicle 100 may rotate around one or more rotation axis. For example, the rotation axis may include a roll axis, a yaw axis, and a pitch axis. It should be understood that the motor 160 can be a DC motor or an AC motor, a brushless motor or a brushed motor.

The flight control system can include a flight controller and a sensing system. The sensing system is used to measure the attitude information of the unmanned aerial vehicle, that is, the position information and status information of the agricultural unmanned aerial vehicle 100 in space, such as three-dimensional position, three-dimensional angle, three-dimensional velocity, three-dimensional acceleration, and three-dimensional angular velocity, etc. The sensing system may include, for example, at least one of a gyroscope, an ultrasonic sensor, an electronic compass, an inertial measurement unit (IMU), a vision sensor, a global navigation satellite system, and a barometer, etc. For example, a global navigation satellite system may be a Global Positioning System (GPS). The flight controller is used to control the flight of the agricultural unmanned aerial vehicle 100. For example, the flight controller can control the flight of the agricultural unmanned aerial vehicle 100 according to the attitude information measured by the sensing system. It should be understood that the flight controller may control the agricultural unmanned aerial vehicle 100 according to a pre-programmed program instruction, and may also control the agricultural unmanned aerial vehicle 100 by responding to one or more control instructions from the control terminal.

As shown in FIG. 1, a stand 120 of an agricultural unmanned aerial vehicle can also be equipped with a radar 170 that is a rotary radar. The radar 170 can be used for but not limited to ranging.

It should be understood that the above described naming of various components of the agricultural unmanned aerial vehicle is for identification purposes only, and should not be construed as limiting the embodiments of the present disclosure.

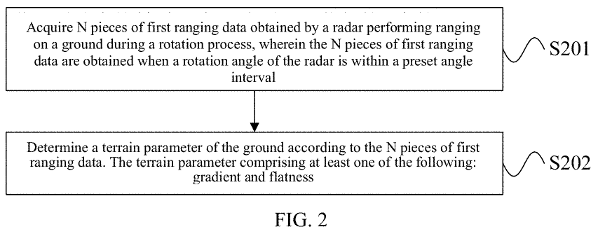

FIG. 2 is a flowchart of a terrain prediction method according to one embodiment of the present disclosure. As shown in FIG. 2, the method in this embodiment may include the following.

At S201, N pieces of first ranging data obtained by a radar performing ranging on a ground during a rotation process are acquired, where the N pieces of first ranging data are obtained when a rotation angle of the radar is within a preset angle interval.

At S202, a terrain parameter of the ground is determined according to the N pieces of first ranging data, where the terrain parameter includes at least one of the following: gradient and flatness.

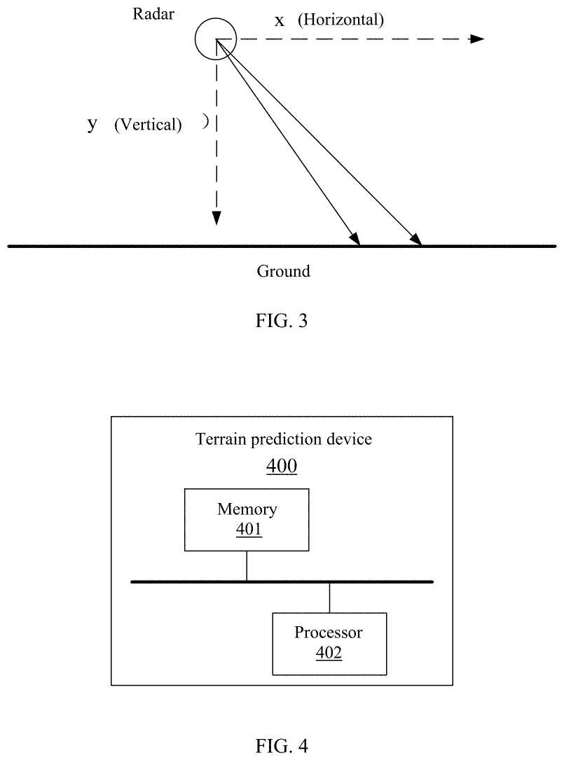

In this embodiment, the ground can be measured by a radar to obtain the distance between the radar and the ground. The radar can rotate. When the radar rotates at different angles, the ranging point of the radar to measure the ground is also different, and hence the distance to the ground detected by the radar may also be different, as shown in FIG. 3. This embodiment acquires the multiple pieces of first ranging data obtained by the radar when measuring the ground while rotating with a rotation angle being within a preset angle interval. The number of pieces of first ranging data is counted as N that is an integer greater than or equal to 2. Each piece of first ranging data reflects the distance of the radar from the ground when it is rotated to the corresponding rotation angle. For a same ranging point, if the ground where the ranging point is at is high, the distance between the radar and the ground is small, and if the ground where the ranging point is at is low, the distance between the radar and the ground is large. Specifically, if a ground is high in one area and low in another area, a low flatness of the ground is indicated. For the same plurality of ranging points, if the distances between the radar and the ground are all small, it is indicated that the gradient of the ground where the plurality of ranging points are located is high. On the other hand, if the distances between the radar and the ground are large, the gradient of the ground where the plurality of ranging points are located is low. Since the ground is a surface and a plurality of points can determine a surface, this embodiment can determine the terrain parameters of a ground according to the multiple pieces of first ranging data obtained from the plurality of ranging points. The terrain parameters include gradient, flatness of the ground.

For example, when the preset angle interval is 60 degrees to 120 degrees, the corresponding terrain parameters of the ground directly below the radar can be determined. When the preset angle interval is −30 degrees to 30 degrees, the corresponding terrain parameters of the ground in front of the radar can be determined. When the preset angle range is 150 degrees to 210 degrees, the corresponding terrain parameters of the ground behind the radar can be determined. It should be noted that the above described examples are for the purpose of illustration and are not limiting. The preset angel interval can be set according to actual needs. If the preset angle interval of this embodiment is 60 degrees to 120 degrees, the first ranging data can be obtained by the radar ranging from the ground at a rotation angle of 60 degrees, 60.6 degrees, 61.2 degrees, 61.8 degrees, and so on, which will not be repeated here.

In this embodiment, a terrain parameter of the ground, such as gradient and flatness, etc. is determined according to the multiple pieces of first ranging data obtained by ranging the ground when within a preset angle interval while rotating. Since each piece of first ranging data reflects the distance between the radar and the ground ranging point when the radar is rotated to the corresponding rotation angle, the multiple pieces of first ranging data can reflect the terrain change of the ground, and hence the gradient and flatness, etc. can be predicted accordingly. In this embodiment, the ranging data is obtained by the radar, and the radar is not required to directly contact the ground, thereby avoiding the noise interference caused by the direct contact and achieving higher accuracy of the ground terrain prediction.

Each piece of first ranging data includes the horizontal distance of the radar from the ground ranging point, and the vertical distance of the radar from the ground ranging point. Since the rotation angle of the radar is different, the signal transmission direction of the radar is different, resulting in different ground ranging points, and hence the ground ranging point varies with the rotation angle of the radar. In this embodiment, in order to avoid the situation that the distance between the radar and the ground ranging point is same while the terrain of the ground is different, which causes subsequent inaccurate terrain predictions, the first ranging data includes the above-mentioned horizontal distance and vertical distance that can be obtained according to the distance between the radar and the ground ranging point and the rotation angle of the radar corresponding to the ground ranging point. Specifically, for the same distance between the radar and the ground ranging point, if the radar has a larger horizontal distance from the ground ranging point and a small vertical distance, it can be considered that the gradient of the ground is higher. On the other hand, if the radar has a smaller horizontal distance from the ground ranging point and a large vertical distance, it can be considered that the gradient of the ground is lower.

In some embodiments, a possible implementation method of above described S201 may include the following steps A and B:

At step A, M pieces of second ranging data obtained by a radar performing ranging on a ground during a rotation process are acquired, where the M pieces of second ranging data are all the ranging data obtained when the radar is performing ranging on the ground with a rotation angle in a preset angle interval, and M is an integer greater than or equal to N.

In this embodiment, all the ranging data obtained by the radar when the rotation angle of the radar is within a preset angle interval during rotation are acquired. These ranging data are referred to as M pieces of second ranging data and M is an integer greater than or equal to N.

In some embodiments, a possible implementation method of step A may include steps A1 and A2.

At step A1, all the second ranging data of the ground ranging for one revolution of the radar and the rotation angle of the radar corresponding to each piece of second ranging data are obtained.

At step A2, the second ranging data corresponding to the rotation angles of the radar located in the preset angle interval according to the preset angle interval are obtained and determined as the M pieces of second ranging data.

In this embodiment, one revolution of the radar corresponds to a rotation of the radar by a total of 360 degrees. For example, if one revolution of the radar corresponds to 600 light grids, every time the radar rotates for 0.6 degree indicates that the radar rotates to a corresponding light grid, and then a range measurement is triggered, and hence 600 pieces of ranging data can be obtained. In addition, this embodiment also records the rotation angle of the radar corresponding to each piece of ranging data. The ranging principle of a radar can be obtained by referring to the related description in the existing technologies, which will not be repeated here. Then the second ranging data corresponding to the rotation angle of the radar located in the preset angle interval according to the preset angle interval are obtained. For example, if the preset angle interval is 60-120 degrees, the second ranging data corresponding to 60, 60.6, 61.2, . . . , 118.8, 119.4, and 120 degrees can be filtered out and hence a total of 100 pieces of second ranging data can be obtained, that is, M is equal to 100.

At step B, N pieces of first ranging data are acquired according to the M pieces of second ranging data.

In this embodiment, the second ranging data is data obtained by actual ranging of the radar. After the above described M pieces of second ranging data are obtained, the N pieces of first ranging data used for performing terrain prediction can be obtained according to the M pieces of second ranging data, where N is an integer smaller than or equal to M.

In some embodiments, a possible implementation method of above described step B may include step B1.

At step B1, the N pieces of first ranging data are determined according to the M pieces of second ranging data and a valid ranging condition including, smaller than or equal to a preset maximum distance and larger than or equal to a preset minimum distance.

In this embodiment, the validity of each piece of ranging data is judged. A radar has a dead zone in a short range and a longest ranging distance. Therefore, a valid ranging condition can be set and expressed as [dₘᵢₙ, dₘₐₓ], that is, a valid second ranging data should be larger than or equal to and smaller than or equal to dₘₐₓ. In this embodiment, the N pieces of first ranging data determined according to the M pieces of second ranging data and the valid ranging condition are used to predict the terrain of the ground and errors of the ranging data are avoided to improve the accuracy of the terrain prediction.

In some embodiments, a possible implementation method of above described step B1 may include steps B11 and B12.

At step B11, the second ranging data satisfying the described valid ranging condition are determined as N pieces of second ranging data from the described M pieces of second ranging data.

In this embodiment, all the second ranging data smaller than or equal to a preset maximum distance and larger than or equal to a preset minimum distance are determined from the M pieces of second ranging data as the N pieces of second ranging data.

At step B12, the N pieces of first ranging data are determined according to the N pieces of second ranging data.

In this embodiment, the N pieces of first ranging data are determined according to the N pieces of second ranging data that meet the valid ranging condition determined above.

In a possible implementation method, the N pieces of second ranging data may be determined as the N pieces of first ranging data, that is, the first ranging data is equal to the second ranging data.

In another possible implementation method, the N pieces of first ranging data are obtained by smoothing the N pieces of second ranging data. For example, the N pieces of second ranging data are sorted according to an order of the rotation angles of the radar corresponding to the second ranging data. For example, the first piece of second ranging data is the second ranging data d₁ corresponding to 60 degrees, the second piece of second ranging data is the second ranging data d₂ corresponding to 60.6 degrees, and so on. Then it is determined that the first piece of second ranging data is the first piece of first ranging data, that is, D₁ is equal to d₁, and the Nth piece of second ranging data is the Nth piece of first ranging data, that is, D_{N} is equal to d_{N}. The average value of the (j−1)th piece of second ranging data (i.e., dⱼ₋ᵢ), the jth piece of second ranging data (i.e., dⱼ), and the (j+1)th piece of second ranging data (i.e., dⱼ₊ᵢ) is then determined as the jth piece of first ranging data, that is, Dⱼ=[dⱼ₋₁+dⱼ+dⱼ₊₁]/3, where j is an integer larger than or equal to 2 and smaller than or equal to N−1.

It should be noted that Dⱼ is not limited to the average value of the three of dⱼ and its adjacent left one and right one, and may also be the average value of dⱼ and its adjacent left two and right two. Correspondingly, the first and second piece of first ranging data are respectively equal to the first and second piece of second ranging data, and the (N−1)th and Nth piece of first ranging data are respectively equal to the (N−1)th and Nth piece of second ranging data. In this embodiment, adjacent three, four, and so on can also be used for smoothing with similar method, and will not be repeated here.

Further, the above dⱼ can be one value, that is, the distance between the radar and the ground ranging point. In this embodiment, after the smoothing process is performed, the horizontal distance xⱼ and the vertical distance yⱼ in the corresponding first ranging data are obtained according to the corresponding rotation angle of the radar.

Further, the above dⱼ can include two values, that is, the horizontal distance and the vertical distance between the radar and the ground ranging point. In this embodiment, the horizontal distance can be smoothed to obtain the horizontal distance in the first ranging data, or the vertical distance can be smoothed to obtain the vertical distance in the first ranging data.

In some embodiments, a possible implementation method of above described S202 may include the following steps C and D:

At step C, a linear fitting is performed on the N pieces of first ranging data by a least square method to obtain a linear function.

Specifically, a linear function of the vertical distance between the radar and the ground ranging point and the horizontal distance between the radar and the ground ranging point is constructed, and can be expressed as shown in Equation 1 for example: y=ax+b+c, where y is the vertical distance between the radar and the ground ranging point, x is the horizontal distance between the radar and the ground ranging point, and a, b, and c are unknown at this time. Then the slope and intercept in the linear function are determined according to the N pieces of first ranging data, the linear function, and a least square method. The N pieces of first ranging data are known, and each piece of first ranging data includes the horizontal distance and the vertical distance between the radar and the corresponding ground ranging point. The slope (e.g., a) and the intercept (e.g., b) of the linear function are determined by substituting the known values of the N groups of x and y into the above Equation 1, and then using the least square method.

It should be noted that this embodiment is not limited to the above described least square method, and a filtering method can also be adopted.

At step D, terrain parameters of the ground are determined according to the linear function.

In this embodiment, the gradient of the ground can be determined according to the slope of the linear function. For example, the larger the slope of the linear function, the larger the gradient of the ground, and the smaller the slope of the linear function, the smaller the gradient of the ground; and/or, the flatness of the ground can be determined according to the slope and the intercept of the linear function.

The following describes how to determine the slope and the intercept in a linear function according to the N pieces of first ranging data, the linear function, and the least square method.

In a possible implementation method, a residual in the linear function corresponding to each piece of first ranging data is determined according to the N pieces of first ranging data and the linear function, where the residual corresponding to each piece of first ranging data is a function of the slope and the intercept of the linear function. For example, c=yᵢ−axᵢ−b, where yᵢ is the vertical distance in the ith first ranging data, and xᵢ is the horizontal distance in the ith first ranging data. Then a weighted sum of squared residuals corresponding to the N pieces of ranging data is determined according to the residuals corresponding to various pieces of first ranging data and the weighting coefficients of the residuals. The weighted sum of squared residuals is, for example, expressed as shown in Equation 2:

$$Q = {\sum }_{i = 1}^{n} {{w}_{i} ( {y}_{i} - {ax}_{i} - b )}^{2} ,$$

where Q is the weighted sum of squared residuals, wᵢ is the weighting coefficient of the residual corresponding to the ith first ranging data, and the value of n is equal to the value of N.

In this embodiment, the value of the slope and the value of the intercept of the linear function are determined according to the weighted sum of squared residuals. Specifically, the value of the slope and the value of the intercept of the linear function are determined based on that the first derivative of the weighted sum of squared residuals to the slope is equal to a first preset value and the first derivative of the weighted sum of squared residuals to the intercept is equal to a second preset value.

The first preset value and the second preset value can be set to 0 in order to minimize the value of Q and optimize the values of a and b. Accordingly, the first derivative of the weighted sum of squared residuals (Q) to the slope (a) is equal to 0, and the first derivative of the weighted sum of squared residuals (Q) to the intercept (b) is equal to 0. This can be shown, for example, in Equation 3:

$$\frac{\partial Q}{\partial a} = 2 {\sum }_{i = 1}^{n} {w}_{i} ( {y}_{i} - {ax}_{i} - b ) ( - {x}_{i} ) = 0$$

$$\frac{\partial Q}{\partial b} = 2 {\sum }_{i = 1}^{n} {w}_{i} ( {y}_{i} - {ax}_{i} - b ) ( - 1 ) = 0$$

According to the above Equation 3, the estimated value â of a and the estimated value \hat{b} of b can be obtained as shown in Equation 4 below:

$$\hat{a} = \frac{{\sum }_{i = 1}^{n} {w}_{i} {x}_{i} {y}_{i} - {\sum }_{i = 1}^{n} {w}_{i} {x}_{i} {\sum }_{i = 1}^{n} {w}_{i} {y}_{i}}{{\sum }_{i = 1}^{n} {w}_{i} {x}_{i}^{2} - {( {\sum }_{i = 1}^{n} {w}_{i} {x}_{i} )}^{2}}$$

$$\hat{b} = \frac{{\sum }_{i = 1}^{n} {w}_{i} {x}_{i}^{2} {\sum }_{i = 1}^{n} {w}_{i} {y}_{i} - {\sum }_{i = 1}^{n} {w}_{i} {x}_{i} {\sum }_{i = 1}^{n} {w}_{i} {x}_{i} {y}_{i}}{{\sum }_{i = 1}^{n} {w}_{i} {x}_{i}^{2} - {( {\sum }_{i = 1}^{n} {w}_{i} {x}_{i} )}^{2}}$$

In this embodiment, â can be used as the value of the slope a, and \hat{b} can be used as the value of the intercept b.

Correspondingly, according to the slope and intercept of the linear function, a possible implementation method for determining the flatness of the ground is, determining the value of the weighted sum of squared residuals based on the value of the determined slope and the value of the determined intercept. For example, the value of Q is obtained by substituting the value of a (above â) and the value of b (above \hat{b}) into the above Equation 2. Then the flatness of the ground can be determined according to the value of the weighted sum of squared residuals. For example, the larger the value of Q, the more uneven the ground, and the smaller the value of Q, the more flat the ground.

In another embodiment, Equations 4 and 2 as described above can be stored in advance. â and \hat{b} can be obtained by substituting the obtained N pieces of first ranging data into the pre-stored Equation 4. The gradient of the ground can be determined according to â. Then Q can be obtained by substituting the obtained â and \hat{b} into the pre-stored Equation 2. The flatness of the ground can be determined according to the value of Q.

In some embodiments, the weighting coefficients of the residuals corresponding to all of the first ranging data are equal, in which case even if the values of i are different, wᵢ is the same. For example, all wᵢ are equal to 1, or all wᵢ are equal to 1/N, which indicates the sum of the weighting coefficients of the residuals corresponding to the N pieces of first ranging data is equal to 1.

In some embodiments, since the ranging data obtained through radar ranging has an error that increases as distance increases, it is needed to assign a weight to the corresponding first ranging data according to the radar rotation angle.

In a possible implementation method, the weighting coefficient of the residual corresponding to each piece of first ranging data is a trigonometric function of the rotation angle of the radar corresponding to the first ranging data, for example, as shown in Equation 5:

$${w}_{i} = 1 - ( \frac{{k}_{i} - {k}_{min}}{{k}_{max} - {k}_{i}} )$$

where kₘᵢₙ is the minimum value of a preset angle interval, kₘₐₓ is the maximum value of a preset angle interval, and kᵢ is the rotation angle of the radar corresponding to the ith piece of first ranging data.

In some embodiments, if the sum of the weighting coefficients of the residuals corresponding to the N pieces of first ranging data is equal to 1, the above described trigonometric function needs to be normalized. The weighting coefficient of the residual is, for example, as shown in Equation 6:

$${w}_{i} = \frac{1 - ( \frac{{k}_{i} - {k}_{min}}{{k}_{max} - {k}_{i}} )}{{\sum }_{i = 1}^{N} ( 1 - ( \frac{{k}_{i} - {k}_{min}}{{k}_{max} - {k}_{i}} ) )}$$

In another possible implementation method, the weighting coefficient of the residual corresponding to each piece of first ranging data is a Gaussian function of the rotation angle of the radar corresponding to the first ranging data, for example, as shown in Equation 7:

$${w}_{i} = \frac{1}{σ \sqrt{2 π}} {e}^{- \frac{{( {k}_{i} - μ )}^{2}}{2 {σ}^{2}}}$$

where kᵢ is the rotation angle of the radar corresponding to the ith piece of first ranging data, σ is the variance, and μ is the median of the preset angle interval.

The shape of the above function can be adjusted according to the value of the variance. The smaller the variance, the larger the weight of the median of the preset angle interval. The larger the variance, the smaller the weight of the median of the preset angle interval. The value of the variance can be set in advance according to the actual needs. If the preset angle interval is 60-120 degrees, μ is 90 degrees.

In some embodiments, if the sum of the weighting coefficients of the residuals corresponding to the N pieces of first ranging data is equal to 1, the above described Gaussian function needs to be normalized. The weighting coefficient of the residual is, for example, as shown in Equation 8:

$${w}_{i} = \frac{\frac{1}{σ \sqrt{2 π}} {e}^{- \frac{{( {k}_{i} - μ )}^{2}}{2 {σ}^{2}}}}{{\sum }_{i = 1}^{N} \frac{1}{σ \sqrt{2 π}} {e}^{- \frac{{( {k}_{i} - μ )}^{2}}{2 {σ}^{2}}}}$$

In this embodiment, after a flatness of the ground is determined, the flatness can be used in the height determination and obstacle avoidance scheme of an unmanned aerial vehicle. After a gradient of the ground is determined, the slope can be used to guide the subsequent actions of an unmanned aerial vehicle.

In some embodiments, the radar in the above embodiments may be an electromagnetic wave radar, or may be a lidar.

An embodiment of the present disclosure also provides a computer storage medium storing program instructions, and the execution of the program may implement a part or all of the steps of the terrain prediction method shown in FIG. 2 and its corresponding embodiments.

FIG. 4 is a schematic structural diagram of a terrain prediction device according to one embodiment of the present disclosure. As shown in FIG. 4, the terrain prediction device 400 in this embodiment may include a memory 401 and processor 402 that are connected to each other through a bus. The memory 401 may include a read-only memory and a random access memory, and provide instructions and data to the processor 402. A part of the memory 401 may further include a non-volatile random access memory.

The memory 401 is used to store a computer program.

The processor 402 is used to call and execute the computer program to perform the following operations: acquiring N pieces of first ranging data obtained by a radar performing ranging on a ground during a rotation process, where the N pieces of first ranging data are obtained when a rotation angle of the radar is within a preset angle interval and N is an integer greater than 1, and determining a terrain parameter of the ground according to the N pieces of first ranging data, where the terrain parameter includes at least one of the following: gradient and flatness.

In some embodiments, the first ranging data includes the horizontal distance and the vertical distance of the radar from the ground ranging point, where the ground ranging point varies with the rotation angle of the radar.

In some embodiments, the processor 402 is specifically used for performing a linear fitting on the N pieces of first ranging data by a least square method to obtain a linear function; and determining terrain parameters of the ground according to the linear function.

In some embodiments, the processor 402 is specifically used for constructing a linear function of the vertical distance between the radar and the ground ranging point and the horizontal distance between the radar and the ground ranging point; determining the slope and intercept in the linear function according to the N pieces of first ranging data, the linear function, and a least square method; and determining the gradient of the ground according to the slope of the linear function, and/or, determining the flatness of the ground according to the slope and the intercept of the linear function.

In some embodiments, when the slope and the intercept in a linear function are determined according to the N pieces of first ranging data, the linear function, and the least square method, the processor 402 is specifically used for determining a residual in the linear function corresponding to each piece of first ranging data according to the N pieces of first ranging data and the linear function, where the residual corresponding to each piece of first ranging data is a function of the slope and the intercept of the linear function; determining a weighted sum of squared residuals corresponding to the N pieces of ranging data according to the residuals corresponding to various pieces of first ranging data and the weighting coefficients of the residuals; and determining the value of the slope and the value of the intercept of the linear function according to the weighted sum of squared residuals.

When the flatness of the ground is determined according to the slope and intercept of the linear function, the processor 402 is specifically used for determining the value of the weighted sum of squared residuals based on the value of the determined slope and the value of the determined intercept; and determining the flatness of the ground according to the value of the weighted sum of squared residuals.

In some embodiments, the processor 402 is specifically used for determining the value of the slope and the value of the intercept of the linear function based on that the first derivative of the weighted sum of squared residuals to the slope is equal to a first preset value and the first derivative of the weighted sum of squared residuals to the intercept is equal to a second preset value.

In some embodiments, the first preset value and the second preset value are 0.

In some embodiments, the weighting coefficients of the residuals corresponding to all of the first ranging data are equal, or, the weighting coefficient of the residual corresponding to each piece of first ranging data is a trigonometric function or a Gaussian function of the rotation angle of the radar corresponding to the first ranging data.

In some embodiments, the sum of the weighting coefficients of the residuals corresponding to the N pieces of first ranging data is equal to 1.

In some embodiments, the processor 402 is specifically used for acquiring M pieces of second ranging data obtained by a radar performing ranging on a ground during a rotation process, where the M pieces of second ranging data are all the ranging data obtained when the radar is performing ranging on the ground with a rotation angle in a preset angle interval, and M is an integer greater than or equal to N; and acquiring N pieces of first ranging data according to the M pieces of second ranging data.

In some embodiments, the processor 402 is specifically used for determining the N pieces of first ranging data according to the M pieces of second ranging data and a valid ranging condition including, smaller than or equal to a preset maximum distance and larger than or equal to a preset minimum distance.

In some embodiments, the processor 402 is specifically used for determining the second ranging data satisfying the described valid ranging condition as N pieces of second ranging data from the described M pieces of second ranging data; and determining N pieces of first ranging data according to the N pieces of second ranging data.

In some embodiments, the processor 402 is specifically used for determining the N pieces of second ranging data as the N pieces of first ranging data; or, obtaining the N pieces of first ranging data by smoothing the N pieces of second ranging data.

In some embodiments, the processor 402 is specifically used for sorting the N pieces of second ranging data according to an order of the rotation angles of the radar corresponding to the second ranging data; determining that the first piece of second ranging data is the first piece of first ranging data, and the Nth piece of second ranging data is the Nth piece of first ranging data; and determining the average value of the (j−1)th piece of second ranging data, the jth piece of second ranging data, and the (j+1)th piece of second ranging data as the jth piece of first ranging data, where j is an integer larger than or equal to 2 and smaller than or equal to N−1.

In some embodiments, the processor 402 is specifically used for obtaining all the second ranging data of the ground ranging for one revolution of the radar and the rotation angle of the radar corresponding to each piece of second ranging data; and obtaining and determining the second ranging data corresponding to the rotation angle of the radar located in the preset angle interval according to the preset angle interval as the M pieces of second ranging data.

In some embodiments, the above described terrain prediction device 400 can be a radar, or can be an unmanned aerial vehicle, or can be a control terminal of the unmanned aerial vehicle. In some embodiments, the unmanned aerial vehicle can be an agricultural unmanned aerial vehicle.

The device in this embodiment can be used to implement the technical solutions of the above described method in the embodiments of the present disclosure. The implementation principles and technical effects are similar, and are not repeated here.

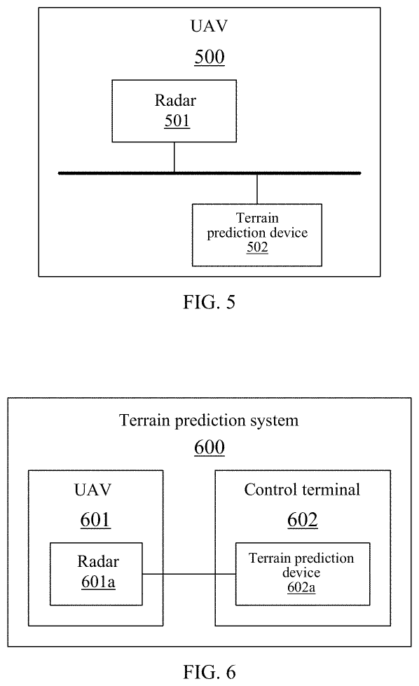

FIG. 5 is a schematic structural diagram of an unmanned aerial vehicle according to one embodiment of the present disclosure. As shown in FIG. 5, the unmanned aerial vehicle 500 in this embodiment includes a radar 501 and a terrain prediction device 502, which are communicatively connected to each other. The terrain prediction device 502 may adopt the structure of the embodiment shown in FIG. 4. Correspondingly, the terrain prediction device 502 may implement the technical solution shown in FIG. 2 and its corresponding embodiments. The implementation principles and technical effects are similar and will not be repeated here. It should be noted that the unmanned aerial vehicle 500 also includes other components that are not shown here.

FIG. 6 is a schematic structural diagram of a terrain prediction system according to one embodiment of the present disclosure. As shown in FIG. 6, the terrain prediction system 600 in this embodiment includes an unmanned aerial vehicle 601 and a control terminal 602, which are communicatively connected with each other. The control terminal 602 is used to control the unmanned aerial vehicle 601.

The unmanned aerial vehicle 601 is equipped with a radar 601a and the control terminal 602 includes a terrain prediction device 602a. The terrain prediction device 602a may adopt the structure of the embodiment shown in FIG. 4. Correspondingly, the terrain prediction device 602a may implement the technical solution shown in FIG. 2 and its corresponding embodiments. The implementation principles and technical effects are similar and will not be repeated here. It should be noted that the unmanned aerial vehicle 601 and the control terminal 602 also include other components that are not shown here.

Those having ordinary skills in the art should understand that all or part of the steps of the above described method embodiments can be implemented by a program instruction related hardware. The program can be stored in a computer-readable storage medium. When the program is executed, the program includes steps of the above described method embodiments. The storage medium can be any medium that can store program codes, for example, a read-only memory (ROM), a random access memory (RAM), a magnetic disk, or an optical disk.

The present disclosure has been described with the above embodiments, but the technical scope of the present disclosure is not limited to the scope described in the above embodiments. Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the claims.

What is claimed is:

1. An unmanned aerial vehicle (UAV) comprising:
a radar configured to perform ranging on a ground during rotation; and
a terrain prediction device communicatively connected to the radar and including:
a memory storing a computer program; and
a processor configured to execute the computer program to:
acquire N pieces of ranging data each being obtained by the radar when a rotation angle of the radar is within a preset angle interval, N being an integer greater than 1; and
determining a terrain parameter of the ground according to the N pieces of ranging data, the terrain parameter including at least one of a gradient or a flatness.

2. The UAV of claim 1, wherein the each of the N pieces of ranging data includes a horizontal distance and a vertical distance of the radar from a ground ranging point, the ground ranging point varying with the rotation angle of the radar.

3. The UAV of claim 1, wherein the processor is further configured to execute the computer program to:
perform a linear fitting on the N pieces of ranging data by a least square method to obtain a linear function; and
determine the terrain parameter of the ground according to the linear function.

4. The UAV of claim 3, wherein the processor is further configured to execute the computer program to:
construct the linear function as a linear function between:
a vertical distance between the radar and a ground ranging point, and
a horizontal distance between the radar and the ground ranging point;
determine a slope and an intercept of the linear function according to the N pieces of ranging data, the linear function, and the least square method; and
perform at least one of:
determining the gradient of the ground according to the slope of the linear function; or
determining the flatness of the ground according to the slope and the intercept of the linear function.

5. The UAV of claim 4, wherein the processor is further configured to determine the slope and the intercept of the linear function by:
determining, for each of the N pieces of ranging data, an expression of a corresponding residual as a function of the slope and the intercept of the linear function according to the piece of ranging data and the linear function;
determining an expression of a weighted sum of squares of the residuals corresponding to the N pieces of ranging data according to the residuals corresponding to the N pieces of ranging data and weighting coefficients of the residuals; and
determining an estimated value of the slope and an estimated value of the intercept of the linear function according to the expression of the weighted sum.

6. The UAV of claim 5, wherein the processor is further configured to determine the flatness of the ground by:
determining a value of the weighted sum based on the estimated value of the slope and the estimated value of the intercept; and
determining the flatness of the ground according to the value of the weighted sum.

7. The UAV of claim 5, wherein the processor is further configured to execute the computer program to:
determine a first equation with the first derivative of the expression of the weighted sum with respect to the slope equaling a first preset value;
determine a second equation with the first derivative of the expression of the weighted sum with respect to the intercept equaling a second preset value; and
determining the estimated value of the slope and the estimated value of the intercept based on the first equation and the second equation.

8. The UAV of claim 7, wherein the first preset value and the second preset value are 0.

9. The UAV of claim 5, wherein the weighting coefficients of the residuals are equal.

10. The UAV of claim 5, wherein the weighting coefficients of the residuals are a trigonometric function or a Gaussian function of the rotation angles of the radar corresponding to the N pieces of ranging data.

11. The UAV of claim 5, wherein a sum of the weighting coefficients equals 1.

12. The UAV of claim 1, wherein:
the N pieces of ranging data are N pieces of first ranging data; and
the processor is further configured to execute the computer program to:
acquire M pieces of second ranging data each being obtained by the radar when the rotation angle of the radar is within the preset angle interval, M being an integer greater than or equal to N; and
acquire the N pieces of first ranging data according to the M pieces of second ranging data.

13. The UAV of claim 12, wherein the processor is further configured to execute the computer program to determine the N pieces of first ranging data according to the M pieces of second ranging data and a valid ranging condition.

14. The UAV of claim 13, wherein one of the M pieces of second ranging data satisfies the valid ranging condition if a detected distance in the one of the M pieces of second ranging data is smaller than or equal to a preset maximum distance and larger than or equal to a preset minimum distance.

15. The UAV of claim 13, wherein the processor is further configured to execute the computer program to:
determine N pieces of second ranging data satisfying the valid ranging condition from the M pieces of second ranging data; and
determining the N pieces of first ranging data according to the N pieces of second ranging data.

16. The UAV of claim 15, wherein the processor is further configured to execute the computer program to determine the N pieces of second ranging data as the N pieces of first ranging data.

17. The UAV of claim 15, wherein the processor is further configured to execute the computer program to obtain the N pieces of first ranging data by smoothing the N pieces of second ranging data.

18. The UAV of claim 17, wherein the processor is further configured to execute the computer program to:
sort the N pieces of second ranging data according to an order of the rotation angles of the radar corresponding to the N pieces of second ranging data;
determine that the first one of the sorted N pieces of second ranging data as the first one of the N pieces of first ranging data;
determine that the Nth one of the N pieces of second ranging data as the Nth one of the N pieces of first ranging data; and
determine an average value of the (j−1)th one of the N pieces of second ranging data, the jth one of the N pieces of second ranging data, and the (j+1)th one of the N pieces of second ranging data as the jth one of the N pieces of first ranging data, j being an integer larger than or equal to 2 and smaller than or equal to N−1.

19. The UAV of claim 12, wherein the processor is further configured to execute the computer program to:
obtain multiple pieces of ranging data obtained by the radar in one revolution and the rotation angles of the radar corresponding to the multiple pieces of ranging data, respectively; and
obtain, from the multiple pieces of ranging data, M pieces of ranging data corresponding to the rotation angles of the radar within the preset angle interval as the M pieces of second ranging data.
